(19) United States
(12) Patent Application Publication
(10) Pub. No.: US 2006/0233355 A1
(43) Pub. Date: Oct. 19, 2006

(54) Fiber to the home demarcation enclosure

(75) Inventors: John B. Markiewicz, Mentor, OH (US); Keith A. Miller, Twinsburg, OH (US); Christopher S. Grubish, Solon, OH (US)

Correspondence Address: FAY, SHARPE, FAGAN, MINNICH & MCKEE, LLP, 1100 SUPERIOR AVENUE, SEVENTH FLOOR, CLEVELAND, OH, 44114, US

(73) Assignee: Preformed Line Products

(21) Appl. No.: 11/444,833

(22) Filed: May 30, 2006

Related U.S. Application Data
(63) Continuation-in-part of application No. PCT/US04/32925, filed on Oct. 6, 2004.
(60) Provisional application No. 60/508,961, filed on Oct. 6, 2003.

(51) Int. Cl. H04M 1/00

(52) U.S. Cl. 379/413.04

(57) ABSTRACT

A demarcation enclosure apparatus is provided for use with an exterior wall of an associated structure. The enclosure apparatus comprises an enclosure frame extending through the exterior wall of the associated structure and defining access to interior and exterior sides of the associated structure. The apparatus further provides a chassis selectively positionable within the enclosure frame. The chassis being configured to carry electronics and including a partition member separating a provider access area from a customer access area.

This application is a continuation-in-part application of and claims the benefit of PCT Application No. US04032925 US, filed Oct. 6, 2004, which claims the benefit of U.S. Provisional Application Ser. No. 60/508,961, Filed Oct. 6, 2003.

### BACKGROUND

The subject disclosure is directed to a weatherproof demarcation box or demarcation enclosure for housing active electronics attached to an associated home, business, structure, et al. The enclosure can house a variety of electronics that provide numerous services to a customer or end user. For example, telephone connections, cable connections, optic fiber connections, etc. can be routed through the demarcation enclosure. The demarcation enclosure represents the point of connection between a supplier or service provider and the customer or user.

Typical demarcation enclosures are attached to the exterior of a building and are thus subject to extreme heating and cooling from changes in ambient temperature. Additionally, the enclosures are subjected to sunlight which increases the internal temperature of the enclosure thereby affecting the performance of the electronics therein. In extreme cases, the electronics can suffer severe and irreversible damage causing interruption to service. One alternative to prevent the above-described condition is by weatherproofing, i.e. hardening, the electronics directly to prevent heat (or cold) damage. This approach has proven prohibitively expensive.

Another alternative attempted in order to resolve the above-described condition involves placing a heat sink on the back of an enclosure and attaching the electronics box directly to the heat sink. The general idea was that any trapped heat could be conducted to the heat sink and out to a finned area between the back of the enclosure and the mounting surface. This design has a number of shortcomings, such as, enclosure is potentially not water-resistant whereby the enclosed electronics can get wet, and there is not a convenient method to run customer cables between the enclosure and mounting surface without exposing them to the outside environment. The majority of the heat energy developed within the enclosure is generated by the ambient air temperature and sunlight as opposed to the electronics within. The main problem with the finned heat sink is that the heat sink is exposed to the same ambient air temperature which causes the heat sink and the enclosure to heat up, thereby limiting the effect of the heat sink.

Demarcation enclosures heretofore known are installed during construction and are thus susceptible to damage or theft as construction progresses. The electronic service requirements of the customer(s), or potential occupant(s) of the structure, can change during construction. These changes necessitate a technician to go out to the construction site, one or more times, to make appropriate modifications.

### SUMMARY

In accordance with one aspect, there is provided a demarcation enclosure housing on an associate structure including an enclosure frame having access to an interior side of the associated structure and access to an exterior side of the associated structure wherein the frame extends through an exterior wall of the associated structure. The frame is fixedly mounted to the exterior wall and includes a door connected with an exterior side of the enclosure frame. A chassis is removably mounted within the frame for housing electronics wherein the chassis is selectively removable from the frame when the door is in an open position. The chassis includes a partition member separating a provider access area from a customer access area.

In accordance with another aspect, there is provided a demarcation enclosure housing providing an interface between a service provider and a customer including an enclosure frame located in an exterior wall of an associated structure, the enclosure frame having access to interior and exterior sides of the associated structure on opposite sides of the exterior wall. A chassis is selectively positionable within the frame for mounting electronics thereon. Preferably, the chassis is removably mountable on the frame. The frame, on the exterior side, includes a door connected thereto for access to the chassis from the exterior side of the associated structure.

In accordance with another yet aspect, there is provided a demarcation enclosure housing comprising an enclosure frame extending through an exterior wall of an associated structure including a pass-through between an interior side of the associated structure and an exterior side of an associated structure. A removable chassis is mountable within the frame and includes a partition member, for separating a provider access area from a customer access area. The provider access area and the customer access area are in fluid communication with the interior side of the associated structure.

In accordance with yet another aspect, a demarcation enclosure housing is provided comprising an enclosure frame extending through an exterior wall of an associated structure and having access to interior and exterior sides of the associated structure. The frame includes a front wall, at least one side wall, and an open back area for receiving an electronics chassis therein. The chassis can be selectively mounted in the frame from the exterior side of the associated structure.

### BRIEF DESCRIPTION OF THE DRAWINGS

The invention may take physical form in certain parts and arrangements of parts, exemplary embodiments of which will be described in detail in the specification and illustrated in the accompanying drawings, which form a part hereof, and wherein:

FIG. 1 is a perspective view of a first embodiment of an enclosure in accordance with the present invention;

FIG. 2 is a perspective view from the inside of a structure of the first embodiment of the enclosure;

FIG. 3 is an exploded isometric view of the first embodiment of the enclosure;

FIG. 4 is a perspective view from the outside of the structure of a second embodiment of an enclosure in accordance with the present invention;

FIG. 5 is a perspective view from the outside of the structure, partially in section, showing the interior of the enclosure of the second embodiment;

FIG. 6 is a perspective view from the outside of the structure, partially in section, showing the connection between the enclosure and exterior wall sheathing of the second embodiment;

FIG. 7 is a perspective view from the outside of the structure, partially in section, showing the connection between the enclosure and wall studding of the second embodiment;

FIG. 8 is a perspective view from the inside of the structure, partially in section, showing conduit in communication with the enclosure of the second embodiment;

FIG. 9 is an exploded isometric view of the second embodiment of the enclosure according to the present invention;

FIG. 10 is a perspective view from the inside of the structure, showing a mounting arrangement for the enclosure according to the second embodiment;

FIG. 11 is a perspective view from the inside of the structure, showing another mounting arrangement for the enclosure according to the second embodiment;

FIG. 12 is a perspective view from the inside of the structure of a third embodiment of an enclosure according to the present invention;

FIG. 13 is an enlarged front perspective view of a vent cover of the third embodiment of the enclosure;

FIG. 14 is a perspective view of a door in accordance with a fourth embodiment of an enclosure;

FIG. 15 is a perspective view of the door in accordance with the fourth embodiment of the present invention;

FIG. 16 is a perspective view of an enclosure frame in accordance with the fourth embodiment;

FIG. 17 is an exploded view of the door and enclosure frame of FIGS. 15 and 16;

FIG. 18 is a perspective view from the outside of a structure, showing multiple fiber feeds into the enclosure in accordance with the fourth embodiment;

FIG. 19 is a perspective view from the inside of the structure of the enclosure in accordance with the fourth embodiment;

FIG. 20 is a perspective view from the inside of the structure of the enclosure in accordance with the fourth embodiment, showing an alternative venting arrangement;

FIG. 21 is a perspective view of a fifth embodiment of an enclosure frame in accordance with the present disclosure;

FIG. 22 is a perspective view of an enclosure door in accordance with the fifth embodiment;

FIG. 23 is a perspective view of the enclosure frame and door in accordance with the fifth embodiment;

FIG. 24 is a perspective view of a chassis mountable within the frame in accordance with the fifth embodiment; and,

FIG. 25 is a perspective view of the chassis open to the provider side in accordance with the fifth embodiment.

### DETAILED DESCRIPTION

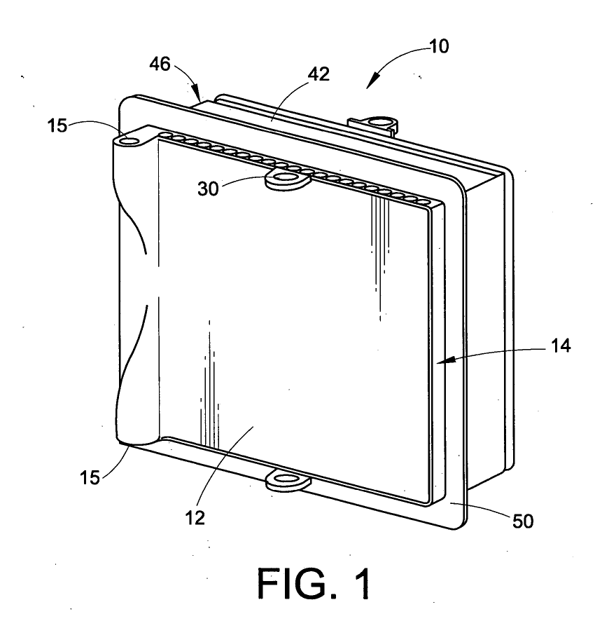

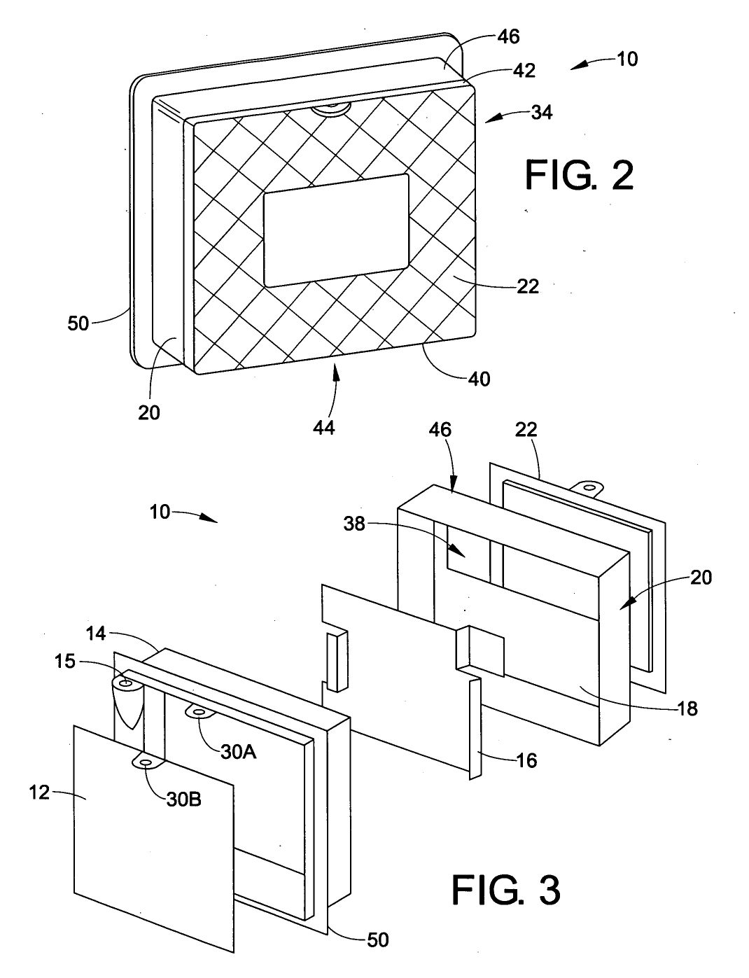

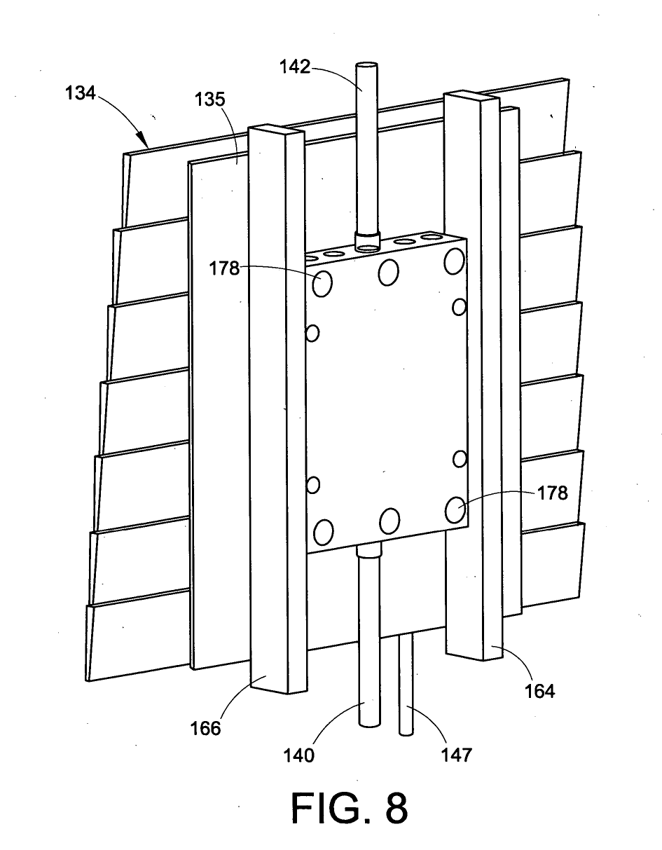

Referring now to the drawings, wherein the showings are for the purposes of illustrating embodiments of the disclosure only and not for the purposes of limiting same, the overall construction of the subject electronic demarcation enclosure 10 can best be understood by reference to FIGS. 1-13. As illustrated therein, one embodiment of the enclosure assembly 10 (FIGS. 1-3) comprises an outside (or provider side), door 12, an outside enclosure member 14, an adapter panel 16, electronics 18, inside, (or user side) enclosure member 20, and an inside door 22. The outside door 12 can include a security mechanism 30 for preventing unauthorized access to the enclosure 10. The security mechanism 30 can include a pair of eye hooks 30A and 30B adapted to receive a lock therebetween. Importantly, it is to be appreciated that the enclosure assembly 10 can be mounted within a wall of an associated structure (FIG. 2), with the outside door 12 being generally flush with an outside surface 34 of the structure. Positioning the enclosure assembly 10 in this manner, reduces the exposure of the enclosure 10 to the elements and reduces the effects from outside ambient temperatures and sunlight. The outside door 12 may include thermal insulation (not illustrated) to further reduce the effects from these elements. It is to be appreciated, that the aforementioned arrangement also reduces the effects from moisture, and humidity. The outside enclosure member 14 can include provider conduit connection ports 15.

As best shown in FIG. 2, one embodiment for venting the interior of the enclosure 38 can include a lower and an upper vent 40, 42 which can extend across a lower and an upper edge 44, 46, respectively, of the inside enclosure member 20. Inside or interior ambient air, found within the structure or home, can thereby be allowed to flow through the enclosure 10 from the lower vent 40 to the upper vent 42 by method of the well-established “chimney effect”. The chimney effect is such that hot air rising will be displaced from the interior of the enclosure 38 and therefore draw in cool air from below to replace it. The enclosure 10 can partially intrude into the interior of a room of the house such that the lower and upper vents 40, 42 can be exposed to the ambient air therein. Due to the relatively moderate temperatures of a structure's interior, having the inside ambient air vented or ‘piped’ into the interior of the enclosure provides better operating conditions for the electronics therein. The outside enclosure member 14 can include a weather flange 50 for sealing against the associated structure.

As best shown in FIG. 3, the enclosure 10 can be split into the two intersecting enclosure members 14, 20 for purposes of being adjustable to different wall thicknesses and to be retrofitted to existing structures. The adapter panel 16 can be provided for the dual purposes of providing flexibility for the inclusion of different suppliers of electronic components and as security between the outside enclosure member 14 and the inside enclosure member 20 of the enclosure assembly 10. It is to be appreciated that the enclosure 10 can extend through an inside surface of the wall or be enclosed on an interior side by the inside surface of the wall. If the enclosure 10 extends through the inside surface of the wall (depicted in FIG. 2), the inside door 22 can be mounted to the inside enclosure member 20 for access to the electronics therein from the interior of the structure.

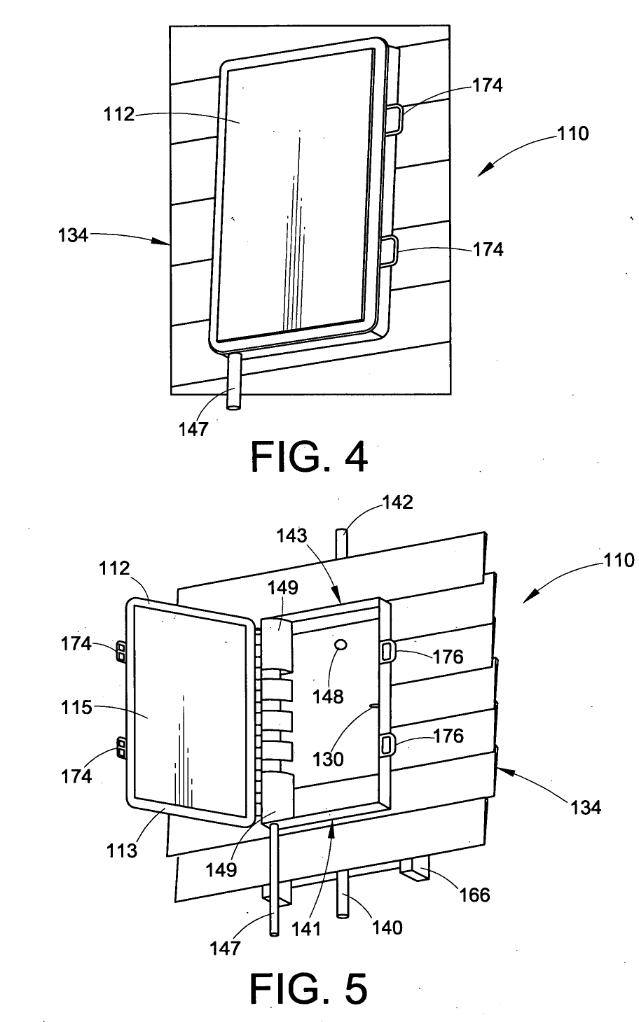

Referring now to FIGS. 4-11, a second embodiment of the enclosure housing 110 is illustrated therein. In accordance with a second embodiment of the invention, a first pipe or cool air intake 140 can be provided at a lower end 141 and a second pipe or hot air exhaust 142 can be provided at an upper end 143 of the enclosure housing 110, whereby the pipes 140, 142 can be in fluid communication with the inside environment 138 of the enclosure and an inside room of the structure. The pipes 140, 142, as will be described in more detail hereinafter, act as a vent for regulating the inside environment 138 of the enclosure thereby providing better operating conditions for the electronics therein. The pipes 140, 142 can include, for example, PVC or semi-rigid conduit providing fluid communication through the enclosure housing 110 and the interior of the structure associated therewith.

One venting arrangement provides the first section of conduit 140 entering a bottom wall 144 of an enclosure frame 145 and the second section of the conduit 142 exiting an upper wall 146 of the enclosure frame 145. As described above, the placement of the sections of the conduit 140, 142 causes hot air to rise out of the enclosure housing 110 and be displaced by cool air drawn in at the bottom of the housing 110. The conduit sections 140, 142 can be centrally positioned through the bottom and top walls 144, 146 of the enclosure frame.

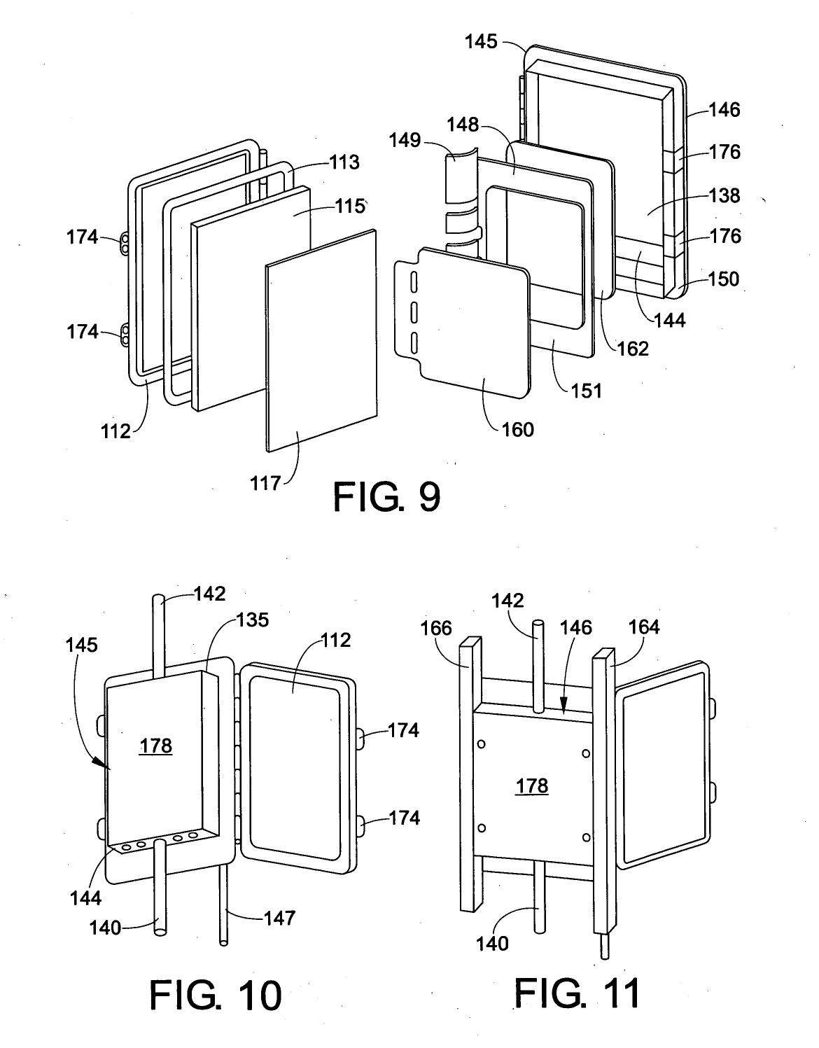

FIGS. 4-7 show the enclosure 110 in the mounted position in a wall 132 of an associated structure. An exterior or outside door 112, can be insulated and include a door gasket 113, insulation 115, and a door stiffener 117 (FIG. 9). The door 112 can also include a security mechanism 130 for preventing unwanted access. A fiber feed 147 (provider side feed) is shown entering the enclosure housing 110 proximal to lower end 141. It is to be appreciated that the fiber feed can enter the enclosure proximal to an upper end. The fiber feed can also enter the enclosure 10 from below ground level and/or from an aerial source.

The inside of the enclosure housing 138 is shown in FIGS. 5-7. As displayed, the exterior door 112 can have door insulation 115 and a door gasket 113. The enclosure frame 145 generally extends through the outside siding 134 of the structure (FIG. 5) and through an exterior wall sheathing 135. Fiber protection shrouds 149 can be located along one side of the enclosure frame 145 to provide protection for the fibers fed within the housing 110. The enclosure frame 145 can include fiber pass-through knockouts 148 for passing fibers through an interior frame 151 of the housing 110.

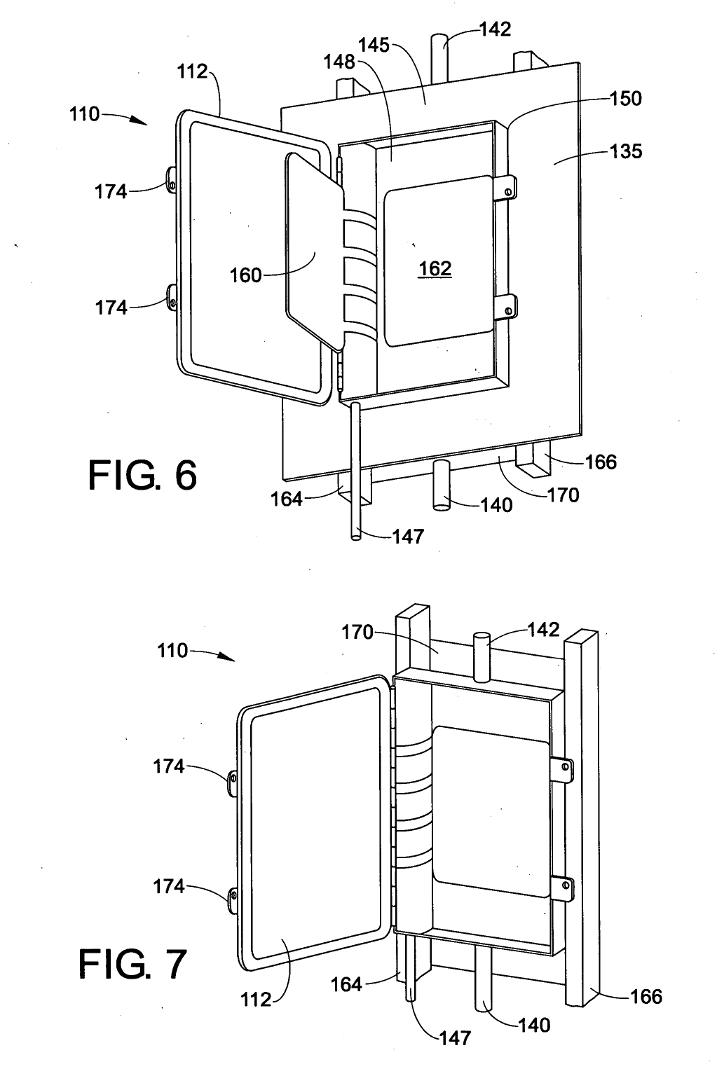

Referring now to FIG. 6, the enclosure frame 145 can include a weather flange 150 between the exterior wall sheathing 135 and the exterior structure siding 134. The housing enclosure 110 can also include a provider inside mounting board 160 hingedly connected to the enclosure frame 145. Additionally, the housing enclosure 110 can include a changeable back panel mounting surface 162.

As shown in FIGS. 6-8, an interior portion of the enclosure frame 145 can generally extend between two interior wall studs 164, 166 and can be surrounded by wall insulation 170. The cool air intake pipe section 140 and the hot air exhaust pipe section 142 can extend through the wall insulation 170. It is to be appreciated that the wall insulation 170 further protects the housing enclosure 110 from extreme outside ambient temperatures.

FIG. 9 shows an exploded view of the enclosure housing 110. The exterior door 112 can include mounting bosses 174 for selectively connecting to an associated latching mechanism 176 on the enclosure frame 145. The customer/provider mounting board 160 can be included and hingedly engaged with the interframe 151. The back panel 162 is shown between the interframe 149 and the housing frame 151. The housing frame 145 is shown with the weather flange 150 therearound.

Referring now to FIGS. 10-11, two alternative mounting arrangements are shown. One mounting arrangement provides for the housing frame 145 to be attached to exterior wall sheathing 135, while a second alternative provides for the housing frame 145 to be attached to interior wall studding 164, 166. The enclosure frame 145 can include knockouts 178 for passing cables therethrough. The knockouts 178 can also provide additional venting options. It is to be appreciated that the cool air intake 140 can extend from the floor of an interior room of the structure to the enclosure housing 110. Similarly, the hot air exhaust pipe 142 can extend from the enclosure housing 110 to a ceiling of the room of the structure. Where desirable, the intake end of the pipe and the exhaust end of the pipe can be connected, for example, to right angle elbows, and can extend to an interior wall (not shown).

Alternatively, the cool air intake 140 can extend from the basement or lower level of the structure to the enclosure housing 110 and the hot air exhaust pipe 142 can extend from the enclosure housing 110 to an attic or upper level of the structure.

As another alternative, the hot air exhaust pipe 142 can extend from the housing enclosure 110 to the outside of the house through the exterior wall sheathing 135 and exterior siding 134. The air exhaust pipe 142 can terminate, for example, under an eave of the structure or in an area protected from the elements (not illustrated). An insect filter guard can be provided to prevent unwanted intrusion from said insects. The position of the air intake 140 and the air exhaust 142 through an interior wall can be at any height appropriate to the room or, as described above, can be at a lower level of the structure for the air intake and similarly an upper level for the air exhaust. It is to be appreciated that the intake pipe 140 and the exhaust pipe 142 can also provide a conduit for feeding connecting wires therethrough.

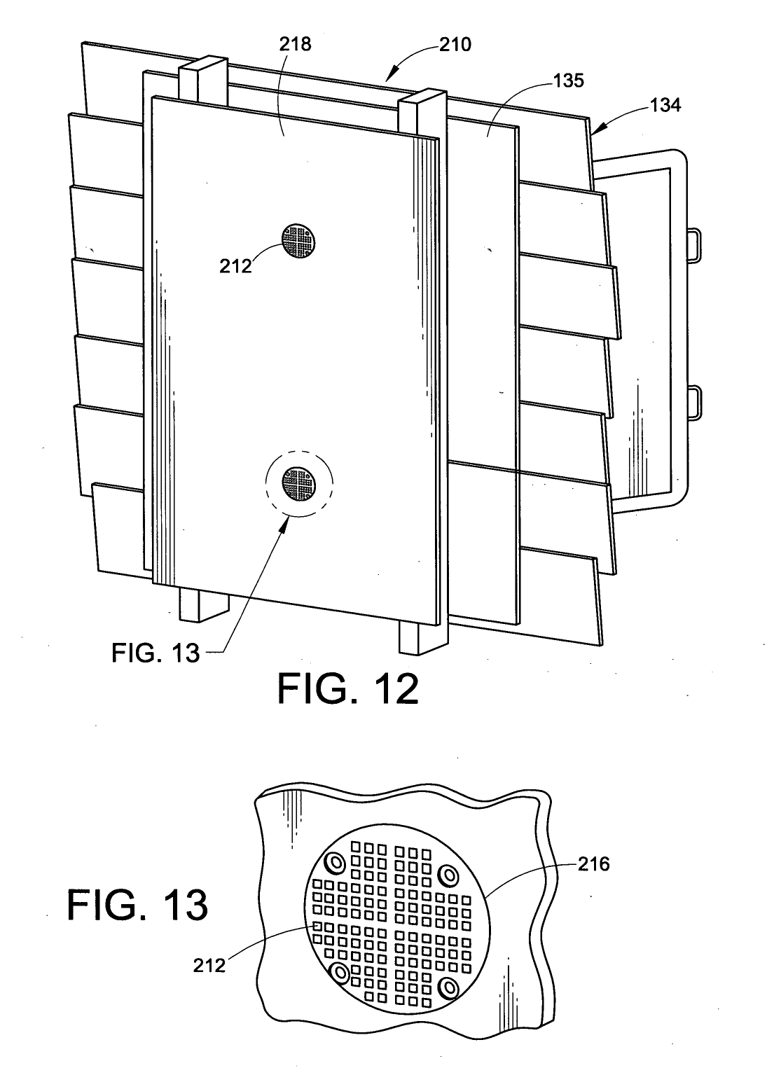

Referring now to FIGS. 12 and 13, a third embodiment of the invention is illustrated. In this embodiment, the enclosure frame or housing 210 includes vents 212 in a back wall of the enclosure frame 210. The vents 212 in the back wall can be exposed through associated openings 216 in an interior wall 218 of a structure, thereby providing fluid communication between the interior of the structure and the enclosure housing 210. FIG. 13 is an enlarged view of the vent 212 in accordance with the third embodiment of the invention.

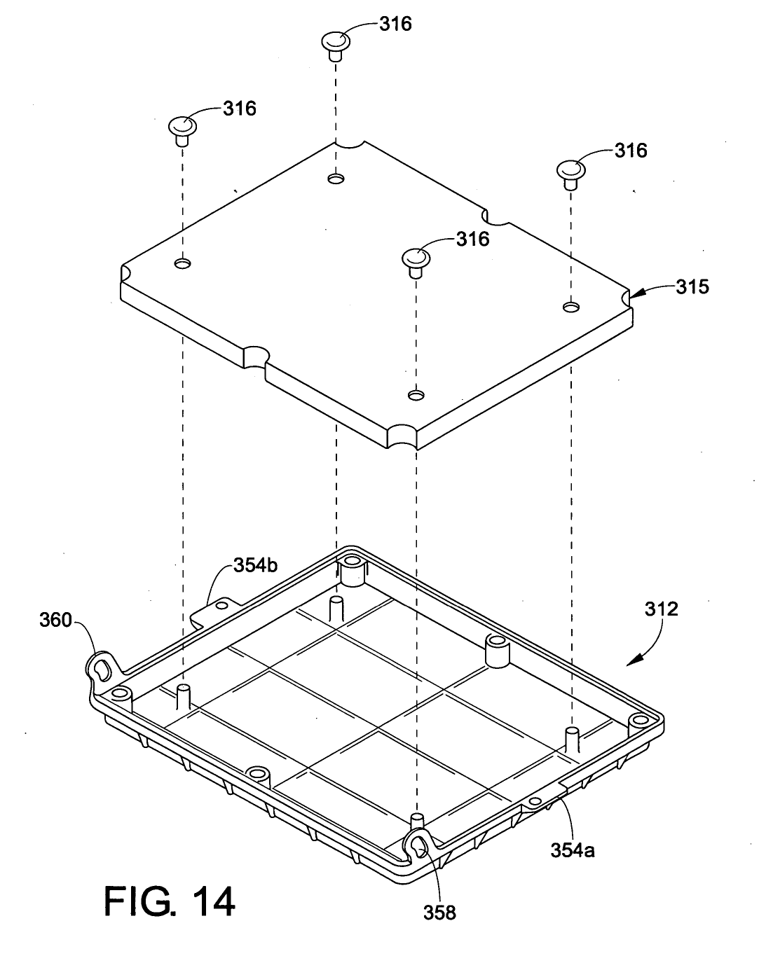

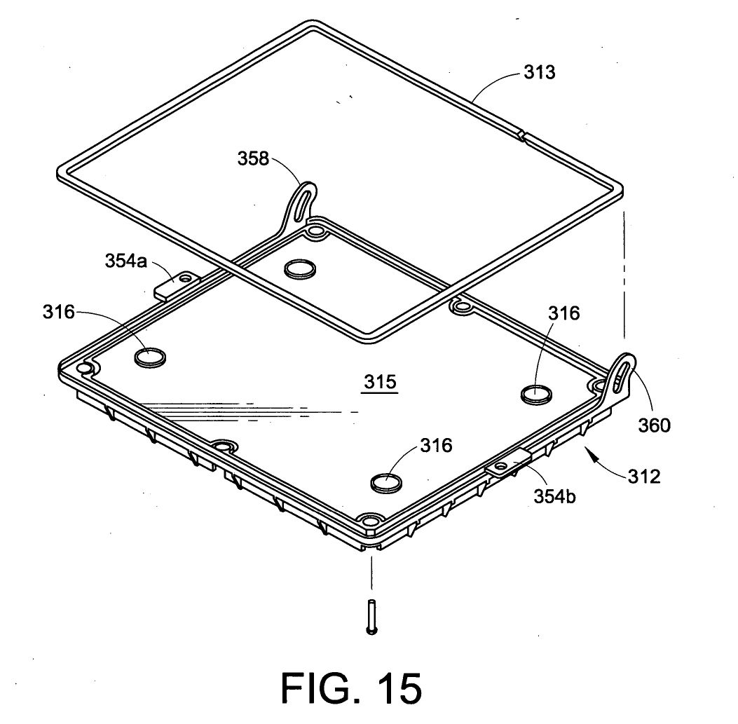

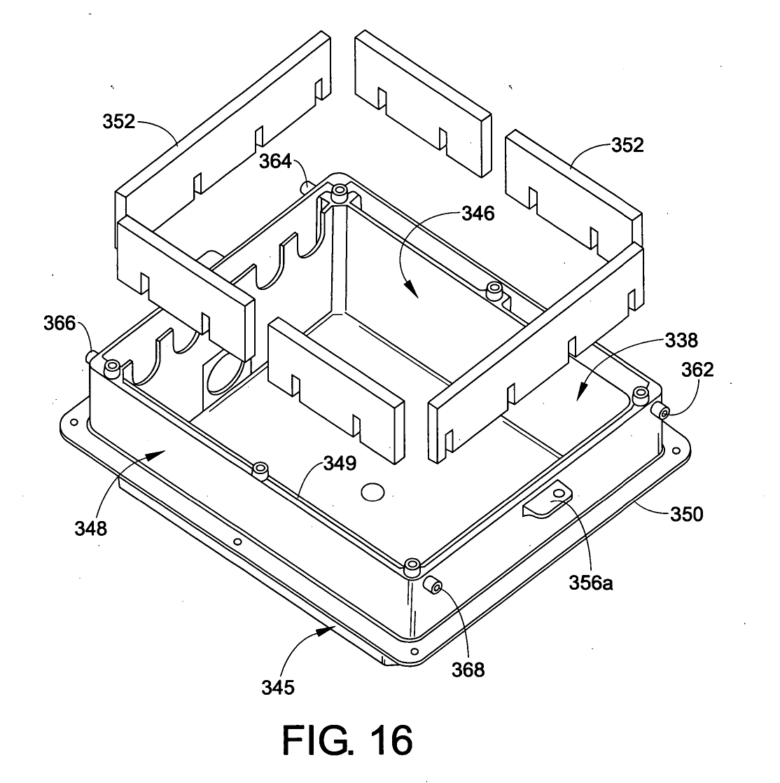

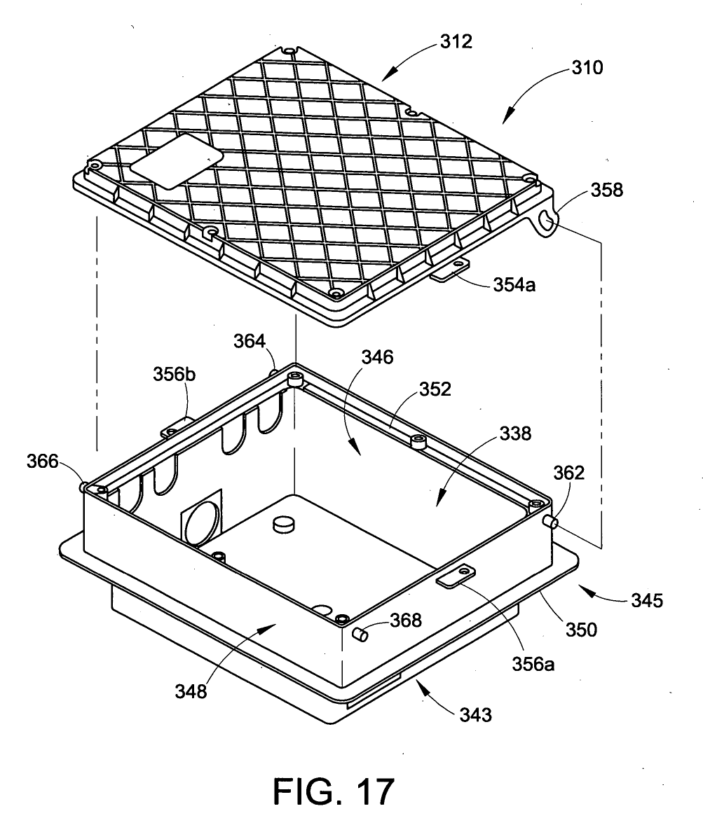

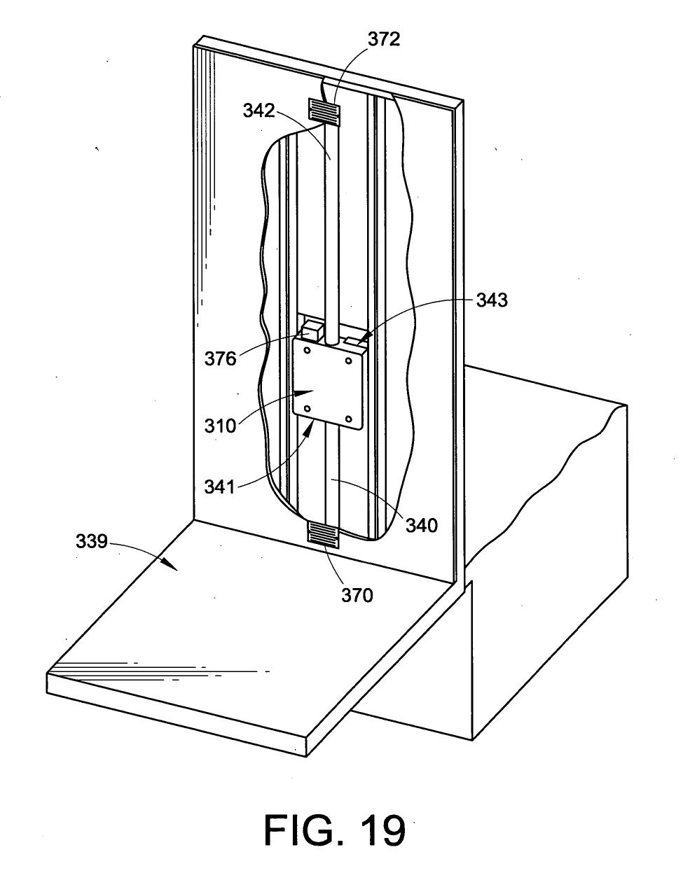

Referring now to FIGS. 14-20, a fourth embodiment of the enclosure housing 310 is illustrated therein. In accordance with a fourth embodiment of the invention, a first pipe or cool air intake 340 can be provided at a lower end 341 and a second pipe or hot air exhaust 342 can be provided at an upper end 343 of an enclosure frame 345, whereby the pipes 340, 342 can be in fluid communication with an interior 338 of the enclosure 310 and an inside room 339 of the structure (FIGS. 17 and 19). The pipes 340, 342 act as a vent for regulating the inside environment 338 of the enclosure 310 thereby providing better operating conditions for the electronics therein. It is to be appreciated that the pipes 340, 342 can act as ducts for housing wires extending to and from the enclosure 310 thereby protecting exterior feed source wires, for example, from unwanted tampering.

Referring now to FIGS. 14-17, an exterior or outside door 312, can include a door gasket 313 and insulation 315. The insulation 315 can be mounted using push pins or tabs 316 to secure the insulation 315 to the door 312

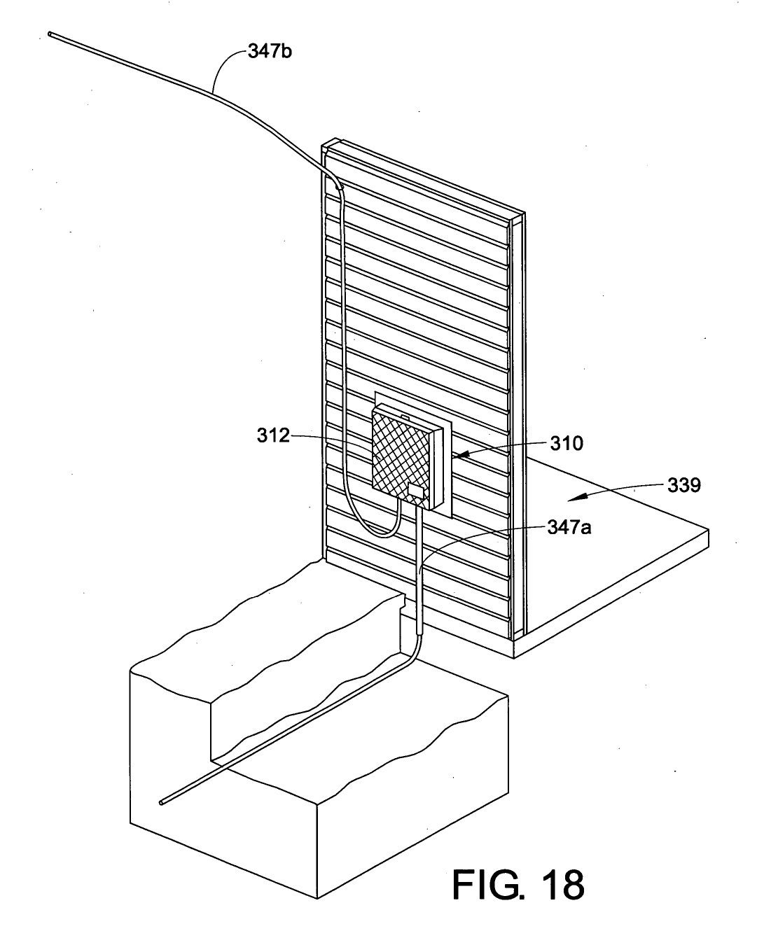

As described above, a portion of the enclosure frame 345 can extend through the outside siding of the structure (FIG. 18). The enclosure frame 345 can include a securable partition for separating a provider access area from a customer access area to prevent unwanted access to the provider electronics (not illustrated). The partition can provide space for passing wires therearound to the provider access area.

Fiber feeds 347a, 347b (provider side feeds) are shown entering the enclosure housing 310 proximal to the lower wall of the enclosure frame 345 from a below ground level source 347a and from an aerial source 347b. It is to be appreciated that the fiber feeds 347a, 347b can enter the enclosure 310 from other walls of the enclosure frame 345. Similarly, the fiber feeds can enter the enclosure 310 through the conduits 340, 342 (not shown).

Referring again to FIGS. 16-17, the enclosure frame 345 can include a nail-on sealing flange 350 for mounting the frame 345 to the wall studding. The frame 345 can include an interior wall 346 and an exterior wall 348 forming a channel 349 therebetween. The channel 349 can provide a space for insulation 352 to further protect the enclosure 310 from the effects of the outside environment. The door 312 can be symmetrical with a pair of latches 354a, 354b on opposing sides for selective securement to mating flanges 356a, 356b on the enclosure frame 345. It is to be appreciated that the door 312 can be selectively hingedly pivoted about opposing sides of the enclosure frame 345. Hinge slots 358, 360 can be pivoted on pins 362, 364, on a first side or pins 366, 368 on a second side of the frame 345.

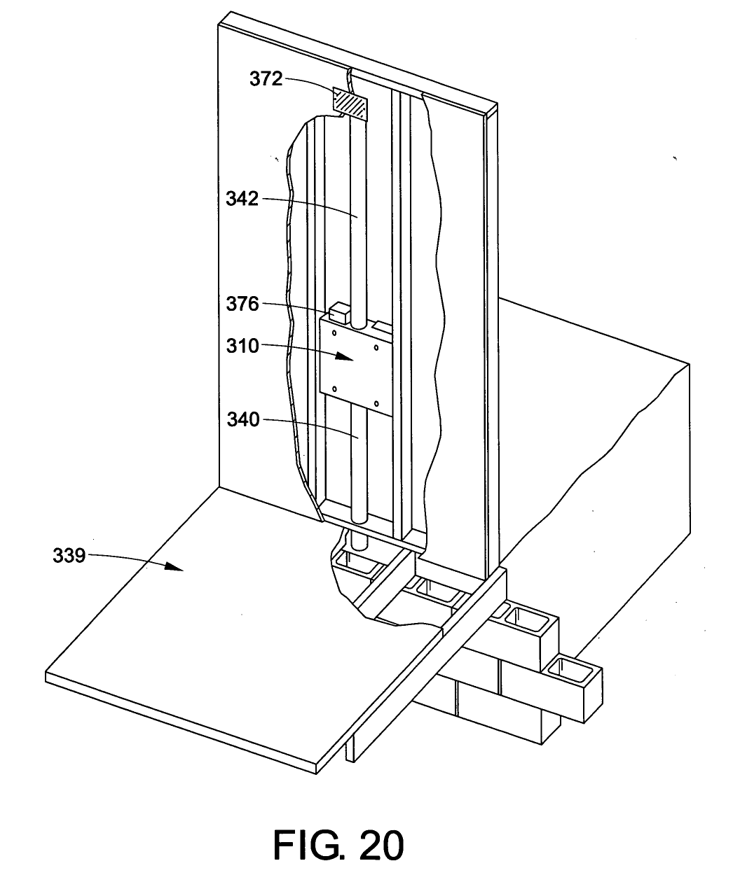

As best shown in FIGS. 19-20, the enclosure frame 345 can generally extend between two interior wall studs. The cool air intake pipe section 340 and the hot air exhaust pipe section 342 can extend between the wall studs. One venting arrangement provides the first section of conduit 340 entering the lower end 341 of the enclosure frame 345 and the second section of the conduit 342 exiting the upper end 343 of the enclosure frame 345. As described above, the placement of terminal ends 370, 372 of the sections of the conduit 340, 342 causes hot air to rise out of the enclosure housing 310 and be displaced by cool air drawn in. The terminal end 370 of the intake conduit 340 can be a vent plate or cover proximal to the floor of an interior room (FIG. 19) for slab construction venting or at a lower position, i.e. basement (FIG. 20) for basement construction venting. The terminal end 372 of the exhaust conduit 342 can be a vent plate or cover proximal to the ceiling of an interior room (FIGS. 19 and 20). An electrical box 376 can be attached to the exterior of the enclosure 310 for supplying power thereto.

Notwithstanding exterior thermal concerns, the active electronics will create heat which will need to be dissipated. The enclosure housing 10, 110, 210, 310 as described above, not only prevents heat to enter the enclosure, but also extracts internal heat through the use of the aforementioned venting arrangements.

Most of the heat contained within the enclosure housing 10, 110, 210, 310 will be created by external influences such as outside ambient air and sunlight. Therefore, performance can be greatly improved by the use of insulation and reflective material in close approximation to the insulation of the structure in order to prevent heat or cold and infrared radiation to either enter or exit the enclosure housing 10, 110, 210, 310. Also, a roof or awning can be installed around the enclosure 10, 110, 210, 310 to further prevent the elements and sunlight from reaching the exterior door of the enclosure housing (not illustrated).

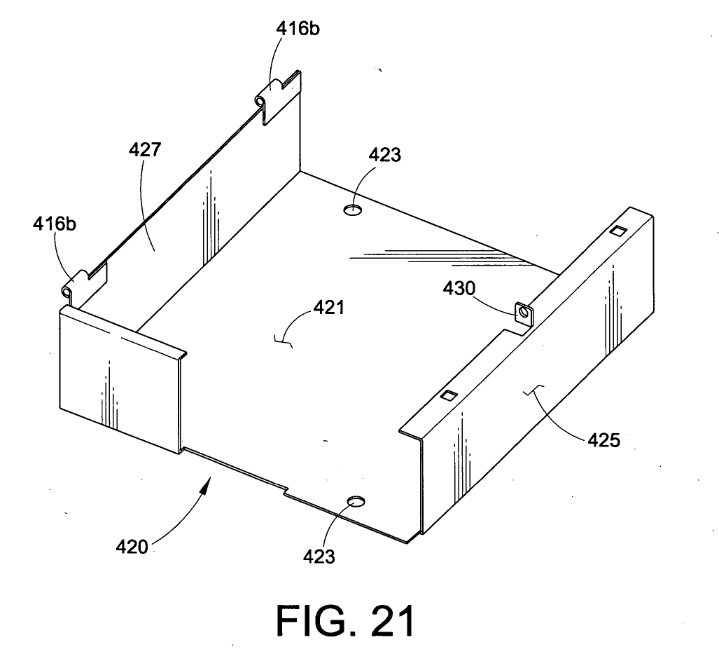

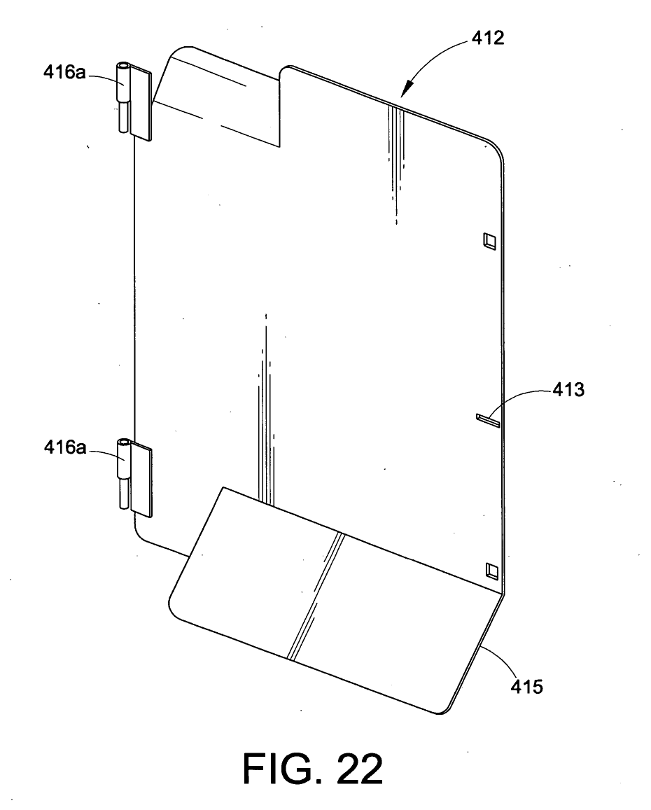

Referring now to FIGS. 21-25, wherein the showings are for the purposes of illustrating a fifth embodiment of the disclosure. As illustrated therein, the overall construction of an electronic demarcation enclosure 410 can best be understood. The fifth embodiment of the enclosure assembly 410 (FIGS. 21-25) comprises a security door 412, a selectively removable mounted chassis member 414 including a partition member 416 separating a customer or user side 417 and an electronic or provider side 418, and a frame member 420. The partition member 416 can include a flange 419 for grasping. The security door 412 can include an opening 413 for receiving a security mechanism or lockable hasp 430 for preventing unauthorized access to the enclosure 410. The security mechanism 430 can be adapted to receive a lock. The security door 412 can include a flange 415 for grasping.

It is to be appreciated that the frame member 420 can be mounted substantially within a wall of an associated structure (not illustrated), with the security door 412 being generally flush with or slightly protruding from an outside surface of the frame member 420. The frame 420 can include a front wall 421 having mounting holes 423 for mounting to wall sheathing or external wall. The frame 420 can further include side walls 425, 427 for supporting the chassis 414 therein. It is to be appreciated that the frame 420 can be mounted between two wall studs as described above. Positioning the enclosure assembly 410 in this manner reduces the exposure of the enclosure 410 to the elements and reduces the effects from outside ambient temperatures and sunlight. The security door 412 can include thermal insulation (not illustrated) to further reduce the effects from these elements. It, is to be appreciated, that the aforementioned arrangement also reduces the effects from moisture, and humidity.

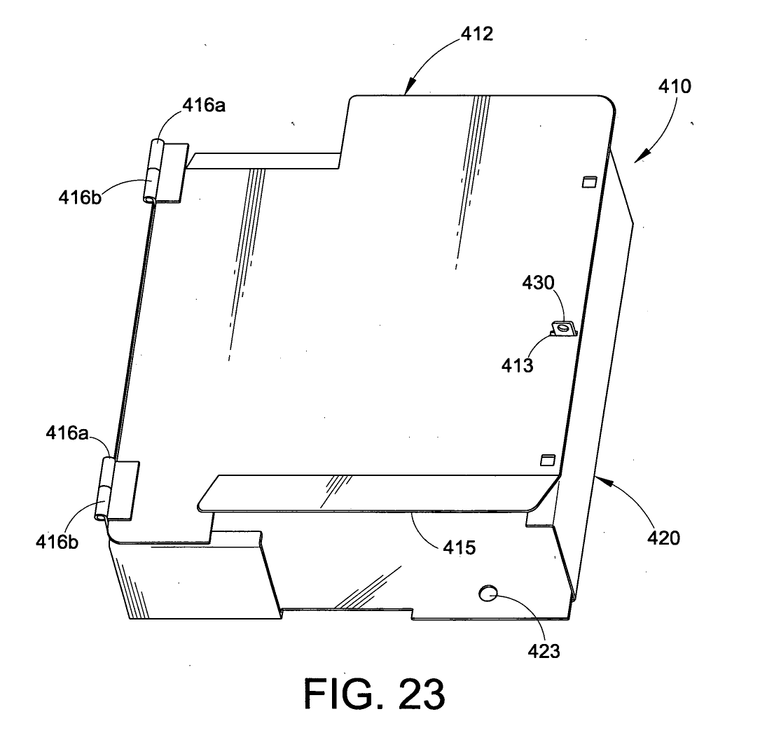

As best shown in FIGS. 23-25, the enclosure 410 can be separated into the frame 420, the door section 412, and the removable chassis member 414. The fixedly mounted frame 420 can be attached to the associated structure during the early stages of construction. The door 412 can be hingedly connected to the frame 420 via mating hinge components 416a, 416b. The chassis 414 can be assembled offsite according to each customer's requirements, modified subject to changing requirements, and held until service is requested or desired. The offsite preparation of the chassis 414 not only provides for customization of the electronic components (i.e. customer premise equipment), but also protects the components from damage and theft during the construction period. In this manner, the relatively expensive electronic components mounted to the chassis 414 are not on the premises until necessary and can be easily mounted into the frame 420 when desired (i.e. when construction nears completion) resulting in a single visit to the construction site.

Although not shown, it is to be appreciated that enclosure housing 410 can include a venting arrangement as described above providing fluid communication through the enclosure housing 410 and the interior of the structure associated therewith.

Optical network connections and battery backup units are examples of the customer premise equipment. The housing 410, along with the ventilation system, can take advantage of equipment designed to operate in indoor environments (i.e. indoor rated hardware) which offers a cost savings over environmentally hardened outdoor units with similar functionality. The security door 412, after removal of the outside cover (not illustrated), enables selective service provider access, equipment installations/modifications, maintenance, and replacement for both service providers and building owners. Thus, access to the chassis 414 for the service providers is available twenty-four hours a day, seven days a week.

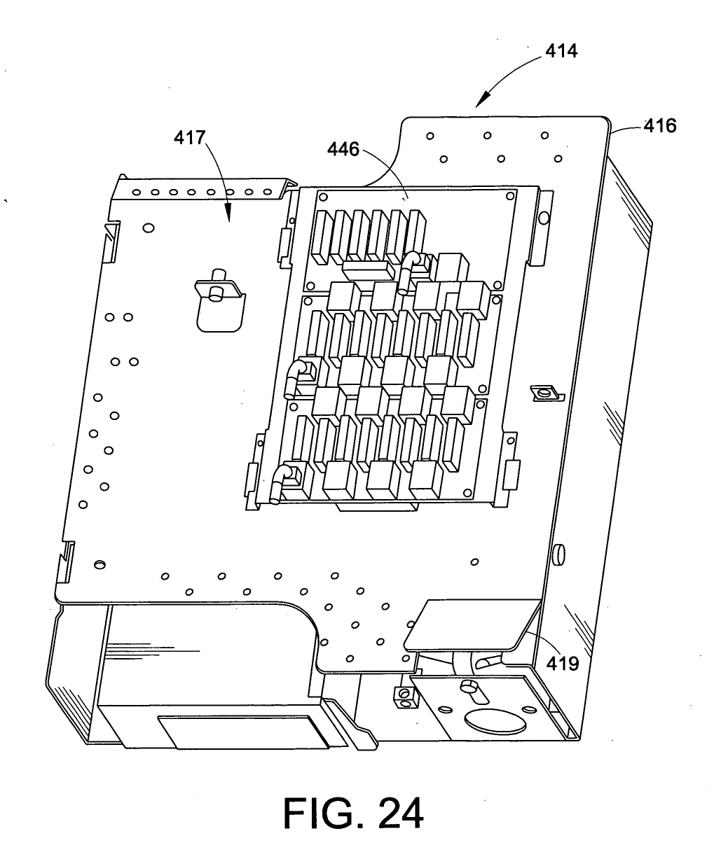

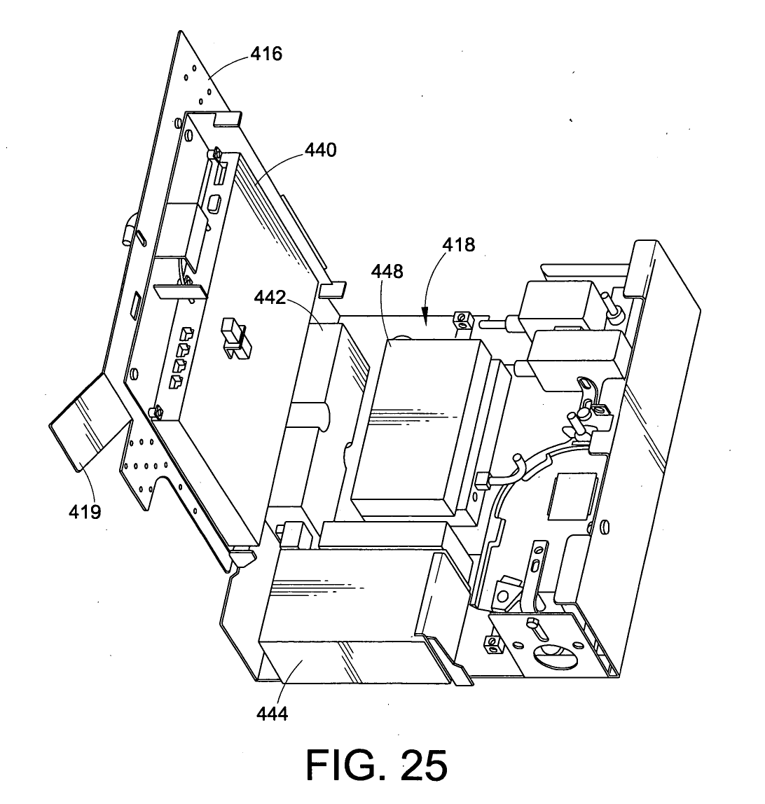

FIGS. 24-25 illustrate the chassis 414 an exemplary ‘loaded’ condition with customer premise equipment. Recessing the customer premise equipment in a building's exterior wall increases the capacity without affecting the exterior aesthetics of the building. This added capacity saves cost by consolidating equipment into a single enclosure. The chassis 414 can include space for an optical network unit 440, a power supply unit 442, a battery backup unit 444, a splice tray 446, switch hardware 448, and other demarcation components. Consolidating the aforementioned equipment into one enclosure eliminates the need for other enclosures and the associated conduit and exposed wires on the building.

While the embodiments shown provide a “vertical” mounting arrangement wherein the enclosure housing is mounted in the wall of a structure, it is to be appreciated that alternative mounting arrangements are possible. For example, one alternative mounting arrangement can include a drawer-like enclosure frame inserted between the floor studs of the structure. This mounting arrangement can provide a “horizontal” mount and can provide for an increase in volume of the electronic components within the enclosure housing.

1. A demarcation enclosure apparatus for use with an exterior wall of an associated structure, the demarcation enclosure apparatus comprising:
an enclosure frame extending through the exterior wall of the associated structure and defining access to an interior side of the associated structure and access to an exterior side of the associated structure; and, a chassis selectively positionable within said enclosure frame, said chassis configured to carry electronics and including a partition member separating a provider access area from a customer access area.

2. The demarcation housing of claim 1, wherein said vent includes an air intake port and an air exhaust port.

3. The demarcation housing of claim 2, wherein said air intake port includes an air intake pipe.

4. The demarcation housing of claim 2, wherein said air exhaust port includes an air exhaust pipe.

5. The demarcation housing of claim 3, wherein said air exhaust port includes an air exhaust pipe.

6. The demarcation housing of claim 1, wherein said enclosure frame is substantially within a wall of the structure.

7. The demarcation housing of claim 3, wherein said air intake pipe extends from an area below said frame up to said frame and said air exhaust pipe extends from said frame to an area above said frame wherein the ambient air flows via a chimney effect.

8. The demarcation housing of claim 4, wherein said air exhaust pipe extends from said frame to an area above said frame.

9. The demarcation housing of claim 8, wherein said air exhaust pipe extends from said frame to said interior side of the structure.

10. A demarcation enclosure housing for providing an interface between a service provider and a customer comprising:
an enclosure frame located in an exterior wall of an associated structure, said enclosure frame having access to interior and exterior sides of the associated structure on opposite sides of the exterior wall; and, a chassis selectively removably mounted within said frame for mounting electronics thereon, said frame, on an exterior side, including a door connected thereto for access to said chassis from said exterior side of the associated structure.

11. The demarcation enclosure of claim 10, wherein said frame extending through the exterior wall of the associated structure and having an interior in fluid communication with said interior side of the structure

12. The demarcation housing of claim 11, wherein said frame includes a vent adapted to allow ambient air from said interior side of the structure to flow through said housing.

13. The demarcation housing of claim 11, wherein said door includes hinge slots and said frame includes hinge pins symmetrically positioned on a first side and a second side of said frame, wherein said door is selectively pivotable about said first or said second side of said frame.

14. The demarcation housing of claim 12, wherein said vent includes an opening proximate to an upper end of said frame and an opening proximate to a lower end of said frame wherein the ambient air flows via a chimney effect.

15. The demarcation housing of claim 14, said vent further includes an exhaust pipe wherein the ambient air flows from said housing to an interior side of the structure.

16. A demarcation enclosure housing comprising:
an enclosure frame extending through an exterior wall of an associated structure and providing a pass through between an interior side of the associated structure and an exterior side of the associated structure; and, a removable chassis mountable within said frame including a partition member for separating a provider access area from a customer access area, said provider access area and said customer access area being in fluid communication with said interior side of the associated structure.

17. The demarcation housing of claim 16, wherein said frame includes an exterior door connected thereto for selective access to said chassis.

18. The demarcation housing of claim 17, wherein said door is selectively lockable for providing selective access to said chassis.

19. The demarcation housing of claim 16, wherein said chassis includes an exterior door connected thereto for selective access to said chassis.

20. The demarcation housing of claim 19, wherein said door is selectively pivotable about a side of said chassis.

21. The demarcation housing of claim 16, wherein said frame includes a vent adapted to allow ambient air to flow through said housing.

22. The demarcation housing of claim 16, wherein said frame includes an interior wall and an exterior wall forming a channel therebetween, said channel includes insulation therein.

23. The demarcation housing of claim 21, wherein said vent includes an air intake port and an air exhaust port.

24. The demarcation housing of claim 23, wherein said air intake port includes an air intake pipe extending from an area below said frame up to said frame.

25. The demarcation housing of claim 24, wherein said air exhaust port includes an air exhaust pipe extending from said frame to an area above said frame.

26. The demarcation housing of claim 25, wherein a terminal end of said air intake pipe and a terminal end of said air exhaust pipe are in fluid communication with said interior side of the associated structure.

27. A demarcation enclosure housing comprising:
an enclosure frame extending through an exterior wall of an associated structure and having access to interior and exterior sides of the associated structure; and,
said frame includes a front wall, at least one side wall, and an open back area for receiving an electronics chassis therein, said chassis being selectively mountable in said frame from said exterior side of the associated structure.

28. The demarcation housing of claim 27, wherein said chassis including a partition member for separating a provider access area from a customer access area;

29. The demarcation housing of claim 27, wherein said frame further includes a vent having an air intake pipe and an air exhaust pipe adapted to allow ambient air to flow through said housing; and,
said air intake pipe and said air exhaust pipe further adapted for housing wires extending to and from said enclosure frame.

30. The demarcation housing of claim 29, wherein the ambient air flows through said vent via a chimney effect.

31. The demarcation housing of claim 27, wherein said frame includes an electrical box attached thereto.

32. The demarcation housing of claim 29, wherein a terminal end of said air intake pipe and a terminal end of said air exhaust pipe are in fluid communication with said interior side of the associated structure.
